(19) United States
(12) Patent Application Publication
(10) Pub. No.: US 2024/0097831 A1
(43) Pub. Date: Mar. 21, 2024

(54) TRANSMISSION SCHEDULING TECHNIQUES

(71) Applicant: ZTE Corporation, Shenzhen (CN)

(72) Inventors: Shuaihua KOU, Shenzhen (CN); Peng HAO, Shenzhen (CN); Wei GOU, Shenzhen (CN); Junfeng ZHANG, Shenzhen (CN)

(73) Assignee: ZTE Corporation, Shenzhen (CN)

(21) Appl. No.: 18/520,395

(22) Filed: Nov. 27, 2023

Related U.S. Application Data
(63) Continuation of application No. PCT/CN2021/111106, filed on Aug. 6, 2021.

(51) Int. Cl. H04L 1/1829; H04W 72/1263; H04W 72/231

(52) U.S. Cl. CPC H04L 1/1854; H04W 72/1263; H04W 72/231

(57) ABSTRACT

Techniques are described to supporting transmission on any serving cell, carrier, or bandwidth part (BWP). An example wireless communication method includes receiving, by a first device from a second device, a first control information that schedules a first transmission on a first cell with the first device, where the first control information indicates a first hybrid automatic repeat request (HARQ) entity associated with the first transmission; and performing an operation to process the first control information.

### CROSS-REFERENCE TO RELATED APPLICATIONS

This application is a continuation of International Patent Application No. PCT/CN2021/111106, filed on Aug. 6, 2021, the contents of which are incorporated herein by reference in their entirety.

### TECHNICAL FIELD

This disclosure is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

Techniques are disclosed for supporting transmission on any serving cell, carrier, or bandwidth part (BWP).

A first example wireless communication method includes receiving, by a first device from a second device, a first control information that schedules a first transmission on a first cell with the first device, where the first control information indicates a first hybrid automatic repeat request (HARQ) entity associated with the first transmission; and performing an operation to process the first control information. In some embodiments, the method further includes receiving, by the first device from the second device, a radio resource control (RRC) signaling that indicates the first HARQ entity associated with a configured grant transmission or a semi-persistent transmission. In some embodiments, the first control information includes a first HARQ process associated with the first transmission, where the operation to process the first control information includes: receiving, by the first device from the second device, a second control information that schedules a second transmission on a second cell with the first device prior to the first transmission, where the second control information indicates the first HARQ entity and the first HARQ process that are associated with the second transmission; and determining, by the first device, that the second transmission is previous transmission of the first transmission in time domain based on the first control information and the second control information.

In some embodiments, the method further includes determining whether the first transmission is a new transmission or a retransmission by comparing a first new data indicator (NDI) value in the first control information to a second NDI value in the second control information. In some embodiments, the first transmission is determined to be a new transmission in response to the first NDI value being different than the second NDI value. In some embodiments, the first transmission is determined to be a retransmission in response to the first NDI value being same as the second NDI value. In some embodiments, the first device includes a user equipment (UE) and the second device includes a base station (BS). In some embodiments, the first device includes a base station (BS) and the second device includes a user equipment (UE).

A second example wireless communication method includes transmitting, by a network device to a communication device, a control information that schedules a transmission on a first cell with the communication device; determining, using a condition, whether to perform the transmission on either the first cell or a second cell; and selectively performing the transmission according to the condition.

In some embodiments, the network device determines that the transmission cannot be performed on the first cell or that the transmission is performed on the second cell in response to the condition that indicates a collision between a transmission resource for the transmission and a slot format in the first cell. In some embodiments, the network device determines that the transmission cannot be performed on the first cell or that the transmission is performed on the second cell in response to the condition that indicates an overlap in the first cell between a transmission resource of the transmission and a first resource that is not to be used for performing transmission with the communication device, and where the network device determines that the first resource is not to be used for performing transmission. In some embodiments, the network device determines that the transmission cannot be performed on the first cell or that the transmission is performed on the second cell in response to the condition that indicates that another signal overlaps with the transmission and that the another signal has a priority that is higher than that of the transmission.

In some embodiments, the network device determines that the transmission is performed on the second cell, and a first set of one or more configurations of the transmission are to be determined by one or more parameters in the control information and one or more configurations of the first cell, or a second set of one or more configurations of the transmission are to be determined by parameters in the control information and one or more configurations of the second cell.

A third example wireless communication method includes receiving, by a communication device from a network device, a signaling that indicates that a serving cell includes a plurality of carriers configured for the communication device and that includes configuration related to the plurality of carriers. Operation 904 includes transmitting, by the communication device to the network device, a first hybrid automatic repeat request acknowledgement (HARQ ACK) codebook, where the first HARQ ACK codebook is determined for the plurality of carriers using: an ordered plurality of start and length indicator value (SLIV) groups in a plurality of slots for each carrier from the plurality of carriers, an ordered plurality of slot indexes or a plurality of sub-slot indexes for each carrier from the plurality of carriers, an ordered plurality of carrier indexes of the plurality of carriers within the serving cell, or an ordered plurality of serving cell indexes of a plurality of serving cells.

In some embodiments, the control information includes a first downlink assignment index (DAI) that indicates an accumulative number of transmissions up to: a carrier from the plurality of carriers, or a serving cell from the plurality of serving cells, or a physical downlink control channel (PDCCH) monitoring occasion. In some embodiments, the control information includes a second downlink assignment index (DAI) that indicates a total number of transmissions in one or more physical downlink control channel (PDCCH) monitoring occasions. In some embodiments, the method further includes transmitting, by the communication device to the network device, a second HARQ ACK codebook, where the second HARQ ACK codebook is determined using: an ordered plurality of HARQ process indexes, an ordered plurality of carrier indexes of the plurality of carriers, and an ordered plurality of serving cell indexes of a plurality of serving cells.

A fourth example wireless communication method includes receiving, by a communication device from network device and at a first time, a control information that indicates a plurality of bandwidth parts (BWPs) configured for the communication device in a serving cell, where the network device indicates a plurality of serving cells for the communication device, where the plurality of serving cells includes the serving cell, where the control information includes a first field that indicates that a first BWP from the plurality of BWPs is active, and where the control information includes a second field that indicates that a second BWP from the plurality of BWPs is non-active; and receiving, at a second time after the first time, an indication to activate the second BWP and to deactivate the first BWP.

In some embodiments, the control information includes a bitmap that includes a plurality of bits, where each bit in the bitmap corresponds to one BWP from the plurality of BWPs. In some embodiments, the method further includes transmitting, by the communication device, a first hybrid automatic repeat request acknowledgement (HARQ ACK) codebook to the network device, where the first HARQ ACK codebook is determined for the plurality of serving cells using: an ordered plurality of start and length indicator value (SLIV) groups in a plurality of slots for each carrier from a plurality of carriers, an ordered plurality of slot indexes or a plurality of sub-slot indexes for each carrier from the plurality of carriers, an ordered plurality of BWP indexes of the plurality of BWPs, or an ordered plurality of serving cell indexes of the plurality of serving cells.

In some embodiments, the control information includes a first downlink assignment index (DAI) that indicates an accumulative number of transmissions up to: a BWP from the plurality of BWPs, or a serving cell from the plurality of serving cells, or a physical downlink control channel (PDCCH) monitoring occasion from a plurality of PDCCH monitoring occasions. In some embodiments, the control information includes a second downlink assignment index (DAI) that indicates a total number of transmissions in one or more physical downlink control channel (PDCCH) monitoring occasions.

In some embodiments, the method further includes transmitting, by the communication device to the network device, a second hybrid automatic repeat request acknowledgement (HARQ ACK) codebook, where the second HARQ ACK codebook is determined using: an ordered plurality of HARQ process indexes, an ordered plurality of BWP indexes of the plurality of BWPs, or an ordered plurality of serving cell indexes of the plurality of serving cells.

A fifth example wireless communication method includes transmitting, by a network device to a communication device and at a first time, a control information that indicates a plurality of bandwidth parts (BWPs) configured for the communication device in a serving cell, where the network device indicates a plurality of serving cells for the communication device, where the plurality of serving cells includes the serving cell, where the control information includes a first field that indicates that a first BWP from the plurality of BWPs is active, and where the control information includes a second field that indicates that a second BWP from the plurality of BWPs is non-active; and transmitting, at a second time after the first time, an indication to activate the second BWP and to deactivate the first BWP.

In some embodiments, the control information includes a bitmap that includes a plurality of bits, where each bit in the bitmap corresponds to one BWP from the plurality of BWPs. In some embodiments, the method further includes receiving, by the network device, a first hybrid automatic repeat request acknowledgement (HARQ ACK) codebook, where the first HARQ ACK codebook is determined for the plurality of serving cells using: an ordered plurality of start and length indicator value (SLIV) groups in a plurality of slots for each carrier from a plurality of carriers, an ordered plurality of slot indexes or a plurality of sub-slot indexes for each carrier from the plurality of carriers, an ordered plurality of BWP indexes of the plurality of BWPs, or an ordered plurality of serving cell indexes of the plurality of serving cells.

In some embodiments, the control information includes a first downlink assignment index (DAI) that indicates an accumulative number of transmissions up to: a BWP from the plurality of BWPs, or a serving cell from the plurality of serving cells, or a physical downlink control channel (PDCCH) monitoring occasion from a plurality of PDCCH monitoring occasions. In some embodiments, the control information includes a second downlink assignment index (DAI) that indicates a total number of transmissions in one or more physical downlink control channel (PDCCH) monitoring occasions. In some embodiments, the method further includes receiving, by the network device from the communication device, a second hybrid automatic repeat request acknowledgement (HARQ ACK) codebook, where the second HARQ ACK codebook is determined using: an ordered plurality of HARQ process indexes, an ordered plurality of BWP indexes of the plurality of BWPs, or an ordered plurality of serving cell indexes of the plurality of serving cells.

In yet another exemplary aspect, the above-described methods are embodied in the form of processor-executable code and stored in a non-transitory computer-readable storage medium. The code included in the computer readable storage medium when executed by a processor, causes the processor to implement the methods described in this patent document.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIG. 1 illustrates an example of a plurality of the scheduled transmissions.

FIG. 2 illustrates an example of transmission switching.

FIG. 3 illustrates an example of a first hybrid automatic repeat request acknowledgement (HARQ-ACK) generation.

FIG. 4 illustrates an example of a downlink assignment indicator (DAI) indication and a HARQ-ACK codebook generation.

FIG. 5 shows an exemplary block diagram of a hardware platform that may be a part of a network device or a communication device.

FIG. 6 shows an example of wireless communication including a base station (BS) and user equipment (UE) based on some implementations of the disclosed technology.

FIG. 7 shows a flowchart of an example method for processing a control information that schedules a transmission.

FIG. 8 shows a flowchart of an example method for selectively performing a transmission based on a condition.

FIG. 9 shows a flowchart of an example method for transmission of HARQ ACK codebook.

FIG. 10 shows a flowchart of an example method for managing bandwidth parts (BWPs).

FIG. 11 shows a flowchart of an example method for indicating one or more BWPs.

### DETAILED DESCRIPTION

In the future wireless communication, a lot of new service types are supported, eMBB, mMTC, URLLC. For URLLC service, the latency of the data over air interface should be quite low to meet the requirement, e.g., 0.5 ms, 1 ms, 2 ms, etc. A serving cell is associated with a HARQ entity. When a transport block is transmitted on a cell as well as a HARQ entity, then the retransmission should be still in this serving cell. However, if there is no available resource for the re-transmission within the allowed range of the latency requirement, the retransmission is not possible. This may lead to a situation where the latency requirement may not be met. Some methods are provided to support transmission on any serving cells, carrier, or BWP to reduce the latency.

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

### I. Embodiment 1

In some embodiments, a UE can be configured with a plurality of serving cells. In the wireless communication, each serving cell can be associated with a HARQ entity. A transmission is transmitted on a serving cell. In Embodiment 1, the transmission may be from the UE to a base station comprising a cell or the transmission may be from the base station comprising the cell to the UE or the transmission may be from a UE to another UE in the cell. A transmission belongs to a HARQ entity. A control information includes a first field. The control information may schedule one or more data transmission or activate/deactivate a plurality of the data transmission. The first field to indicate the HARQ entity for the transmissions. For example, the first field indicates the HARQ entity to which the scheduled transmission belongs. The length of the first field is configured by the network or is ┌log₂ N┐, where N is the number of the configured serving cells for the UE. The correspondence relationship between the value of the first field and the indicated HARQ entity is configured by the network. For example, the first value of the first field corresponds to the first serving cell, the second value of the first field corresponds to the second serving cell, and so on.

The data transmission can be a downlink transmission, uplink transmission or sidelink transmission.

From the perspective of UE, when it receives a scheduled transmission or it would transmit a scheduled transmission, it determines which HARQ entity the scheduled transmission belongs to according to the indication of the first field. The UE also determines whether it is a new transmission or retransmission based on the new data indication in the control information and the previous transmission with the same HARQ entity, if any.

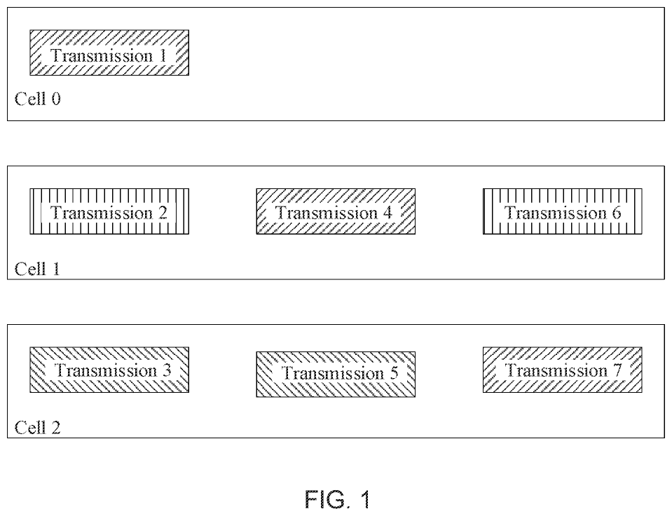

FIG. 1 illustrates an example of a plurality of the scheduled transmissions. A UE is configured with three serving cells denoted by cell 0, cell 1, and cell 2, respectively. Each serving cell is associated with a HARQ entity. Cell 0, cell 1 and cell 2 are associated with HARQ entity 0, HARQ entity 1, HARQ entity 2, respectively. A control information includes a first field indicating the HARQ entity for the transmission scheduled by the control information. The length of the first field is 2 bits. For example, the value ‘00’ of the first field indicates the scheduled transmission belongs to the HARQ entity 0. The value ‘01’ of the first field indicates the scheduled transmission belongs to the HARQ entity 1. The value ‘10’ of the first field indicates the scheduled transmission belongs to the HARQ entity 2.

A serving cell is associated with a HARQ entity. It is understood that the HARQ entity may also be identified by the cell index. In this case, the value ‘00’ of the first field indicates the scheduled transmission belongs to the HARQ entity associated with cell 0. The value ‘01’ of the first field indicates the scheduled transmission belongs to the HARQ entity associated with cell 1. The value ‘10’ of the first field indicates the scheduled transmission belongs to the HARQ entity associated with cell 2.

A control information schedules transmission 1 on the cell 0 with the HARQ process 1 and new data indicator (NDI) equal to 0. The first field in the control information indicates the HARQ entity for the transmission 1 is HARQ entity 0. If there is no previous transmission with HARQ process 1 in the HARQ entity 0, transmission 1 is determined to be a new transmission.

A control information schedules transmission 2 on the cell 1 with the HARQ process 1 and new data indicator (NDI) equal to 0. The first field in the control information indicates the HARQ entity for the transmission 2 is HARQ entity 1. A control information schedules transmission 3 on the cell 2 with the HARQ process 0 and new data indicator (NDI) equal to 0. The first field in the control information indicates the HARQ entity for the transmission 3 is HARQ entity 2.

A control information schedules transmission 4 on the cell 1 with the HARQ process 1. The first field in the control information indicates the HARQ entity for the transmission 4 is HARQ entity 0. From the UE perspective, the transmission 1 in prior to transmission 4 in time domain (or the previous transmission of transmission 4 is transmission 1) due to the fact that they have the same HARQ process and HARQ entity. So the UE determines whether transmission 4 is a new transmission or the retransmission by comparing the NDI in the control information for scheduling transmission 4 with the NDI in the control information for scheduling transmission 1. If the NDI of transmission 4 is 1, the transmission 4 is determined to be a new transmission since the NDI is toggled or is different than the NDI for transmission 1. If the NDI of transmission 4 is 0, the transmission 4 is determined to be a retransmission since the NDI is not toggled or is same as the NDI for transmission 1.

A control information schedules transmission 5 on the cell 2 with the HARQ process 0. The first field in the control information indicates the HARQ entity for the transmission 5 is 2. From the UE perspective, the previous transmission of the transmission 5 is transmission 3 due to the fact that they have the same HARQ process and HARQ entity. The UE determines the whether the transmission 5 is a new transmission or the retransmission by using the same method above.

A control information schedules transmission 6 on the cell 1 with the HARQ process 1. The first field in the control information indicates the HARQ entity for the transmission 6 is 1. From the UE perspective, the previous transmission of the transmission 6 is transmission 2 due to the fact that they have the same HARQ process and HARQ entity. The UE determines the whether the transmission 6 is a new transmission or the retransmission by using the same method above.

A control information schedules transmission 7 on the cell 2 with the HARQ process 1. The first field in the control information indicates the HARQ entity for the transmission 7 is 0. From the UE perspective, the previous transmission of the transmission 7 is transmission 4 due to the fact that they have the same HARQ process and HARQ entity. The UE determines the whether the transmission 7 is a new transmission or the retransmission by using the same method above.

A control information includes a second field. The control information may schedule one or more data transmission or activate/deactivate a plurality of the data transmission. The second field indicates the HARQ entity and the serving cell for the data transmissions. The data transmissions belongs to the indicated HARQ entity and are transmitted on the indicated serving cell. The length of the second field is configured by the network. The correspondence relationship between the value of the second field and the indicated HARQ entity and serving cell is configured by the network.

For example, a UE is configured with two serving cells denoted by the cell 0 and cell 1, respectively. Cell 0 is associated with the HARQ entity 0 and cell 1 is associated with the HARQ entity 1. The control information includes the second field. The length of the second field is 2. For example, the value ‘00’ of the second field indicates the scheduled transmission belongs to the HARQ entity 0 and is transmitted on cell 0. The value ‘01’ of the second field indicates the scheduled transmission belongs to the HARQ entity 0 and is transmitted on cell 1. The value ‘10’ of the second field indicates the scheduled transmission belongs to the HARQ entity 1 and is transmitted on cell 0. The value ‘11’ of the second field indicates the scheduled transmission belongs to the HARQ entity 1 and is transmitted on cell 1.

For the semi-persistent scheduling transmission, or configured grant transmission, the HARQ entity is configured by the RRC signaling and may be further updated by the medium access control (MAC) control element (CE) or downlink control information. For example, a first configured grant is configured in the cell 0. It means that the first configured grant is transmitted on the cell 0. It is further configured by a RRC signaling or a downlink control information that the HARQ entity of the first configured grant is associated with the cell 1. So the transmission of the first configured grant belongs to the HARQ entity associated with the cell 1. Then it is further configured by a MAC CE or downlink control information that the HARQ entity of the first configured grant is associated with the cell 2. Then the transmission of the first configured grant belongs to the HARQ entity associated with the cell 2.

In any case, if the HARQ entity is not indicated for a data transmission, the transmission belongs to the HARQ entity associated with the serving cell in which the data transmission is transmitted.

### II. Embodiment 2

In some embodiments, a UE can be configured with a plurality of serving cells. For a first serving cell of the plurality of serving cells, the first serving cell is configured to associate with one or more other serving cells. It is further configured that the one or more serving cells includes the first candidate cell, the second candidate cell, the third candidate cell, and so on. A first transmission is scheduled to be transmitted on the first serving cell by a first control information. The first transmission is transmitted on the first candidate cell, if the first transmission cannot be transmitted on the first serving cell due to some reasons. One reason for this is that there may be a collision between the first transmission resource and the slot format of the first serving cell. More specifically, at least one of the OFDM symbols for the first transmission resource is uplink symbol or determined for the uplink transmission in case the first transmission is downlink transmission. Alternatively, at least one of the OFDM symbols for the first transmission resource is downlink transmission or determined for the downlink transmission in case the first transmission is uplink transmission.

Another reason is that the first transmission is canceled by an indication from the network. More specifically, the network sends a cancellation indication to the UE to cancel the first transmission. Alternatively, there is one OFDM symbol (or resource element) of the first transmission resource in the time domain or frequency domain overlapping with the resource that is not used for transmitting any signal for this UE based on the indication from the network.

Another reason is that the first transmission in the time domain or the frequency domain overlaps with a second signal that would be transmitted by the UE. The second signal has a higher priority than the first transmission. The first transmission on the first serving cell is canceled.

The first transmission can be a downlink transmission, uplink transmission, or sidelink transmission.

If the first transmission cannot be transmitted on a candidate cell, the first transmission is transmitted on the next candidate cell.

When the first transmission is switched from a cell (e.g., source cell) to another cell (e.g., target cell), some of the configurations of the transmission may be unchanged, which is determined by the parameters in the first control information or the parameters in the first control information and the configuration of the first serving cell together. For example, the frequency domain resource and the time domain resource for the transmission, the resource size, the resource location, the modulation and coding scheme (MCS), redundancy version (RV), antenna ports, transmission configuration indicator (TCI), precoding information and number of layers, priority, corresponding PUCCH resource, etc. Some of the configuration of the transmission may be changed, which is determined based on the configuration of the target cell and the configuration indicated by the first control information. For example, the transmission power for the first transmission is determined by the power control related configuration in the target cell and the transmit power control command indicated by the first control information together.

Even though the first transmission is transmitted on the cell other than the cell that is scheduled for the first transmission originally, the first transmission still belongs to the HARQ entity associated with the cell that is scheduled for the first transmission originally. The PUCCH resource for the HARQ-ACK feedback corresponding to the downlink transmission is unchanged. For example, the first transmission is transmitted on the first candidate cell, the second candidate cell, . . . , (other than the first serving cell), the first transmission still belongs to the HARQ entity associated for the first serving cell. If the first transmission is downlink transmission, the corresponding PUCCH resource is unchanged.

It is required that some of the configurations are the same between the first serving cell and the associated cells. For example, the SCS and the size of the active BWP, the UE processing capability, etc. From the UE perspective, the UE expect that the same SCS and the BWP size for the active BWP are configured for the first serving cell and the associated cells.

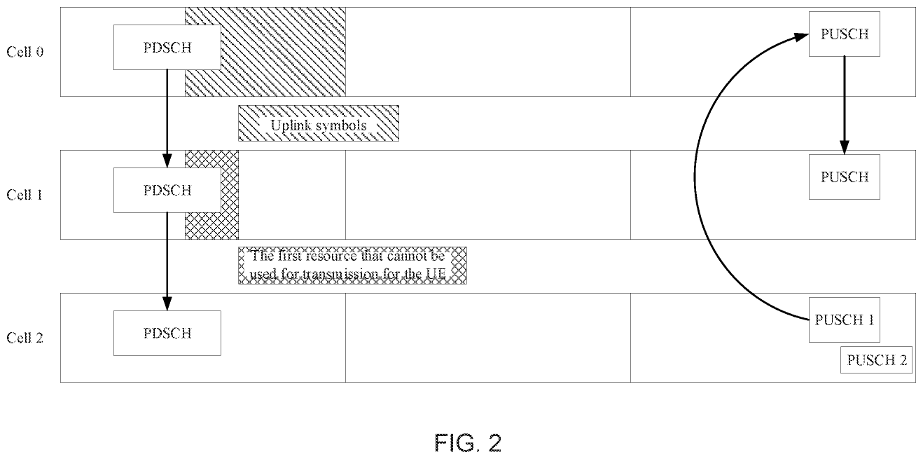

FIG. 2 illustrates an example of the transmission switching. A UE is configured with three serving cells denoted by cell 0, cell 1, and cell 2, respectively. The cell 1 and cell 2 are associated with cell 0 and are the first candidate cell and the second candidate cell for the cell 0, respectively. The cell 2 and cell 0 are associated with cell 1 and are the first candidate cell and the second candidate cell for the cell 1, respectively. The cell 0 and cell 1 are associated with cell 2 and are the first candidate cell and the second candidate cell for the cell 2, respectively.

A downlink control information (DCI, which is not depicted in the FIG. 2) schedules a physical downlink shared channel (PDSCH) transmitted on the cell 0. The PDSCH occupies 4 OFDM symbols (OFDM symbol #3, 4, 5, 6) in a slot in the time domain and 50 resource block (resource block #10˜49) in the frequency domain. Since the PDSCH resource overlaps with the UL symbols in the time domain in cell 0, the PDSCH cannot be transmitted on cell 0. So the PDSCH is transmitted on the cell 1. The resource size and the location for the PDSCH determined by the DCI and the configuration of the cell 0 is not changed. It means that the PDSCH still occupies 4 OFDM symbols (OFDM symbol #3, 4, 5, 6) in a slot in the time domain and 50 resource block (resource block #10˜49) in the frequency domain in cell 1. The network indicates to the UE that a first resource in cell 1 cannot be used for the transmission for this UE. There is overlapping in cell 1 between PDSCH and the first resource. So the PDSCH cannot be transmitted on cell 1. Then the PDSCH is transmitted on cell 2 and occupies 4 OFDM symbols (OFDM symbol #3, 4, 5, 6) in a slot in the time domain and 50 resource block (resource block #10˜49) in the frequency domain in cell 2. From the UE perspective, the UE receives the PDSCH on cell 2 finally. However, the PDSCH still belongs to the HARQ entity associated with the cell 0.

A DCI (not depicted in the FIG. 2) schedules a physical uplink shared channel (PUSCH) transmitted on the cell 2. The PUSCH occupies 3 symbols (symbol #10, 11, 12) in a slot in the time domain and 8 resource blocks (resource block #15˜22) in the time domain. There is another PUSCH (e.g., PUSCH 2) transmitted in the same slot in cell 2 with PUSCH 1. PUSCH 1 and PUSCH 2 overlaps in the time domain and PUSCH 2 has a higher priority than PUSCH 1. The PUSCH 1 cannot be transmitted on the cell 2. So the PUSCH 1 is transmitted on the cell 0. From the UE perspective, it transmits the PUSCH 1 on the cell 0 finally. The PDSCH 1 still belongs to the HARQ entity associated with cell 2.

### III. Embodiment 3

In some embodiments, a UE is configured with a first plurality of serving cells by the network. A signaling is used by the network to indicate to the UE that the serving cell includes multiple carriers and/or the detailed configuration (e.g., frequencies, identifiers, etc.,) of the multiple carriers. Thus, the network indicates to the UE that a serving cell includes a second plurality of carriers (or carrier components) and/or the configuration of the second plurality of carriers. The second plurality of the carriers include a primary carrier (or normal carrier) and one or more second carriers (or supplementary carriers). In some embodiments, the network indicates to the UE that a serving cell includes a second plurality of downlink carrier (or downlink carrier component) and/or the configuration of the second plurality of carriers. The second plurality of the downlink carriers include a primary downlink carrier (or normal downlink carrier) and one or more second downlink carriers (or supplementary downlink carriers). Each carrier or downlink carrier is identified by a carrier index in the embodiment.

To indicate a configuration of a carrier in the second plurality of the carriers, the serving cell and/or the carrier for the configuration should be indicated. It means the serving cell index and/or the carrier index for the configuration should also be included in the configuration signaling. The configuration signaling can be DCI, sidelink control information (SCI), MAC CE, or RRC signaling. For example, when DCI indicates a scheduled transmission, the carrier of the transmission should be indicated by the DCI. The carrier index is included in the DCI. In another example, when a MAC CE configures the TCI state for the PDCCH in a carrier, the carrier index and the serving cell index should be included in the MAC CE. In another example, when RRC signaling configures a BWP for a carrier, the corresponding carrier index and serving cell index should be included in the RRC signaling.

A first HARQ-ACK codebook is generated for the first plurality of the serving cells in the order of the SLIV groups, or in the order of the slot/sub-slot numbers, or in the order of carriers, or in the order of serving cells. For a serving cell including a plurality of carriers, the HARQ-ACK codebook is generated in the order of the carrier index. Or the HARQ-ACK codebook for the second plurality of the carriers are concatenated in the order of the carrier index to form the HARQ-ACK codebook for the serving cell. For example, the first HARQ-ACK codebook is generated by the UE, first in the increasing (or decreasing) order of the SLIV group index, second in the increasing (or decreasing) order of the slot/sub-slot index, third in the increasing (or decreasing) order of the carrier index in the same serving cell, fourth in the increasing (or decreasing) order of the serving cell index.

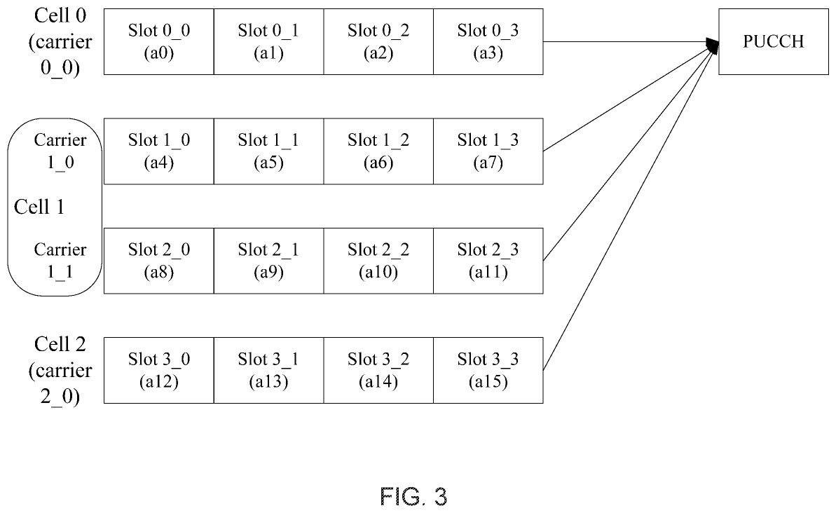

FIG. 3 illustrates an example of the first HARQ-ACK generation. A UE is configured with 3 serving cells by the network denoted by cell 0, cell 1, and cell 2, respectively. It is further configured that cell 1 only includes 1 carrier (carrier 0_0). Cell 1 includes 2 carriers, denoted by carrier 1_0 and carrier 1_1, respectively. Cell 2 only includes 1 carrier (carrier 2_0).

According to the configured offset between the PDSCH and PUCCH resource, there are 4 slots in each serving cell or carrier, where the same slot/sub-slot may be indicated for the PUCCH resource corresponding to the PDSCH in these slots.

First, the HARQ-ACK information bit is generated for each slot in the increasing order of the SLIV group within a slot. Here it is assumed that there is only one SLIV group in each slots and only one HARQ-ACK information bit is generated for a PDSCH. So one HARQ-ACK information bit corresponds to one slot. HARQ-ACK information bit a0 corresponds to slot 0_0. HARQ-ACK information bit a1 corresponds to slot 0_2, and so on, as shown in the FIG. 3.

Second, the HARQ-ACK codebook is generated for each carrier in the increasing order of the slot index within a carrier. So the HARQ-ACK codebook for the carrier 0_0 is a0, a1, a2, a3. The HARQ-ACK codebook for the carrier 1_0 is a4, a5, a6, a7. The HARQ-ACK codebook for the carrier 1_1 is a8, a9, a10, a11. The HARQ-ACK codebook for the carrier 2_0 is a12, a13, a14, a15.

Third, the HARQ-ACK codebook is generated for each serving cell in the increasing order of the carrier index within in a serving cell. So the HARQ-ACK codebook for the cell 0 is a0, a1, a2, a3 since there is only one carrier. The HARQ-ACK codebook for the cell 1 is a4, a5, a6, a7, a8, a9, a10, a11. The HARQ-ACK codebook for the cell 2 is a12, a13, a14, a15 since there is only one carrier.

Last, the final HARQ-ACK codebook for the UE is generated in the increasing order of the serving cell index. So the final HARQ-ACK codebook is a0, a1, a2, a3, a4, a5, a6, a7, a8, a9, a10, a11, a12, a13, a14, a15.

A first control information is transmitted in a first PDCCH monitoring occasion on a first carrier within a first serving cell. As further explained below, a first downlink assignment indicator (DAI) in the first control information indicates the accumulative number of the second transmissions up to the first serving cell and the first PDCCH monitoring occasion (or, the first carrier and the first PDCCH monitoring occasion) in the order of the PDSCH starting time (if any), in the order of the carrier, in the order of the serving cell, and in the order of PDCCH monitoring occasion. The second transmission includes at least a PDSCH scheduled by a PDCCH, a PDCCH indicating the SPS PDSCH release, a PDCCH indicating the SCell dormancy. The second transmission is presented in a carrier of a serving cell and in a PDCCH monitoring occasion.

For example, the first DAI in the first control information indicates the accumulative number of the second transmissions, up to the first carrier and the first PDCCH monitoring occasion, first, in the increasing (or decreasing) order of the PDSCH reception starting time for the same carrier and PDCCH monitoring occasion, second, in the increasing (or decreasing) order of the carrier index for the same serving cell, and third, in the increasing (or decreasing) order of the serving cell index, fourth in the increasing (or decreasing) order of the PDCCH monitoring occasion index.

A second DAI in the first control information indicates the total number of second transmissions up to the first PDCCH monitoring occasion and is updated from PDCCH monitoring occasion to PDCCH monitoring occasion.

A second HARQ-ACK codebook is generated for the UE in the order of the PDSCH starting times, in the order of the carriers, in the order of the serving cells, and in the order of the PDCCH monitoring occasions. For example, the second HARQ-ACK codebook for the UE is generated, first in the increasing (or decreasing) order of the PDSCH starting time for the same carrier and PDCCH monitoring occasion, second in the increasing (or decreasing) order of the carrier index within the same serving cell, third in the increasing (or decreasing) order of the serving cell index in the same PDCCH monitoring occasion, then in the increasing (or decreasing) order of the PDCCH monitoring occasion index. Alternatively, a second HARQ-ACK codebook is generated for the UE in the order of the first DAI value.

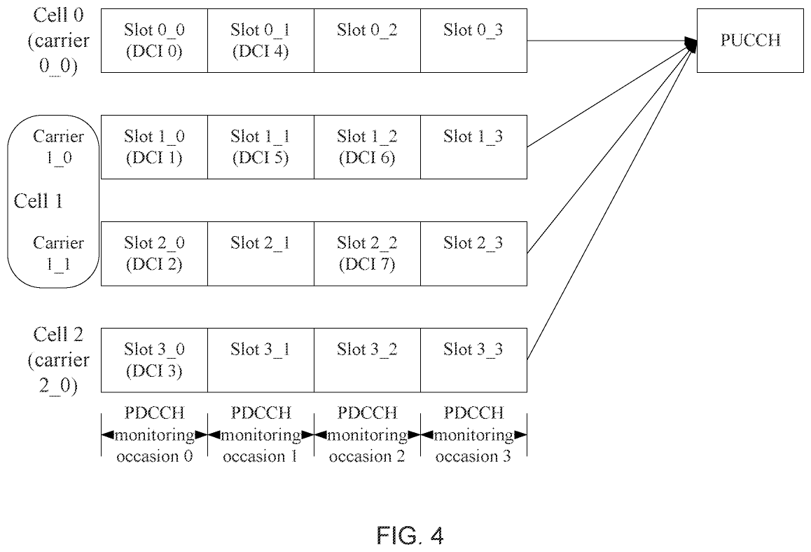

FIG. 4 illustrates an example of the DAI indication and the HARQ-ACK codebook generation. In FIG. 4, all the DCI indicates that the corresponding PUCCH resource for the HARQ-ACK is transmitted on the same slot/sub-slot. Since generally one DCI is carried by a PDCCH, we do not differentiate PDCCH and the carried DCI in the examples. A PDCCH is also represented by the corresponding DCI. Each PDCCH schedules a second transmission. In this case, the number of the PDCCH is equal to the number of the scheduled transmissions.

There are one PDCCH monitoring occasion in each slot, denoted by PDCCH monitoring occasion 0, 1, 2, 3, respectively. There are totally 4 second transmissions (i.e., DCI 0, DCI 1, DCI 2, and DCI 3) transmitted on PDCCH monitoring occasion 0. It means there are totally 4 second transmissions up to PDCCH monitoring occasion 0. So the second DAI in each DCI on the PDCCH monitoring occasion 0 (i.e., DCI 0, DCI 1, DCI 2, and DCI 3) indicates the number of 4. There are totally 2 second transmissions (i.e., DCI 4 and DCI 5) transmitted on the PDCCH monitoring occasion 1. It means there are totally 6 second transmissions up to PDCCH monitoring occasion 1. So the second DAI in each DCI on the PDCCH monitoring occasion 1 (i.e., DCI 4 and DCI 5) indicates the number of the 6. Similarly, there are totally 2 second transmissions (i.e., DCI 6 and DCI 7) transmitted on the PDCCH monitoring occasion 2. It means there are totally 8 second transmissions up to PDCCH monitoring occasion 2. So the second DAI in each DCI on the PDCCH monitoring occasion 2 (i.e., DCI 6 and DCI 7) indicates the number of the 8. It should be noted the number of the transmission is counted from the first transmission, which is indicated by DCI 0.

First, the DCI are sorted within a serving cell and a PDCCH monitoring occasion in the increasing order of the carrier index. So the order of the DCI within the cell 1 in the PDCCH monitoring occasion 0 is DCI 1, DC 2. The order of the DCI within the cell 1 in the PDCCH monitoring occasion 2 is DCI 6, DCI 7.

Second, the DCI are sorted in a PDCCH monitoring occasion in the increasing order of the serving cell index. So the order of the DCI in the PDCCH monitoring occasion 0 is DCI 0, DCI 1, DCI 2, DCI 3. The order of the DCI in the PDCCH monitoring occasion 1 is DCI 4, DCI 5. The order of the DCI in the PDCCH monitoring occasion 2 is DCI 6, DCI 7.

Third, the DCI are sorted in the increasing order of the PDCCH monitoring occasion index. So the order of the DCI is DCI 0, DCI 1, DCI 2, DCI 3, DCI 4, DCI 5, DCI 6, DCI 7.

The first DAI in the DCI 0 indicates the accumulative number of the PDCCH is 1 since there are totally 1 PDCCH up to DCI 0 (i.e., DCI 0). Similarly, the first DAI in the DCI 1 indicates the accumulative number of the PDCCH is 2 since there are totally 2 PDCCH up to DCI 1 (i.e., DCI 0, DCI 1). The first DAI in the DCI 2 and DCI 3 indicate that the accumulative number of the PDCCH is 3 and 4, respectively. In the PDCCH monitoring occasion 1, the order of the DCI is DCI 4, DCI 5. The first DAI in DCI 4 indicates the accumulative number of the PDCCH is 5 since there are totally 5 PDCCH up to DCI 4 (i.e., DCI 0, DCI 1, DCI 2, DCI 3, DCI 4). The first DAI in DCI 5 indicates the accumulative number of the PDCCH is 6 since there are totally 6 PDCCH up to DCI 5 (i.e., DCI 0, DCI 1, DCI 2, DCI 3, DCI 4, DCI 5). In the PDCCH monitoring occasion 2, the order of the DCI is DCI 6, DCI 7. The first DAI in DCI 6 indicates the accumulative number of the PDCCH is 7 since there are totally 7 PDCCH up to DCI 6 (i.e., DCI 0, DCI 1, DCI 2, DCI 3, DCI 4, DCI 5, DCI 6). The first DAI in DCI 7 indicates the accumulative number of the PDCCH is 8 since there are totally 8 PDCCH up to DCI 7 (i.e., DCI is DCI 0, DCI 1, DCI 2, DCI 3, DCI 4, DCI 5, DCI 6, DCI 7). It is noted that the number of the PDCCH is counted from the first PDCCH (i.e., DCI 0).

The second HARQ-ACK codebook is generated first in the increasing order of the carrier index, second in the increasing order of the serving cell index, third in the increasing order of the PDCCH monitoring occasion index, which is the order of the DCI. So the second HARQ-ACK codebook is b0, b1, b2, b3, b4, b5, b6, b7, where b0, b1, b2, b3, b4, b5, b6, b7, correspond to the transmission scheduled by DCI 0, DCI 1, DCI 2, DCI 3, DCI 4, DCI 5, DCI 6, DCI 7, respectively.

A third HARQ-ACK codebook is generated for the first plurality of the serving cells in the order of the HARQ processes, in the order of the carriers, and in the order of the serving cells. For example, the third HARQ-ACK codebook is generated for the first plurality of the serving cells, first in the increasing order of the HARQ process index, second in the increasing order of the carrier index in the same serving cell, third in the increasing order of the serving cell index.

Still referring to FIG. 4, it is further configured that each carrier has 8 HARQ processes. It is assumed that one HARQ-ACK information corresponds to a HARQ process. First, the HARQ-ACK codebook for the carrier are generated in the increasing order of the HARQ process index. So the HARQ-ACK codebook for the carrier 0_0 is a0, a1, a2, a3, a4, a5, a6, a7, which corresponds to the HARQ process 0, 1, 2, 3, 4, 5, 6, 7, respectively, in the carrier 0_0. The HARQ-ACK codebook for the carrier 1_0 is a8, a9, a10, a11, a12, a13, a14, a15, which corresponds to the HARQ process 0, 1, 2, 3, 4, 5, 6, 7, respectively, in the carrier 1_0. The HARQ-ACK codebook for the carrier 1_1 is a16, a17, a18, a19, a20, a21, a22, a23, which corresponds to the HARQ process 0, 1, 2, 3, 4, 5, 6, 7, respectively, in the carrier 1_1. The HARQ-ACK codebook for the carrier 1_1 is a24, a25, a26, a27, a28, a29, a30, a31, which corresponds to the HARQ process 0, 1, 2, 3, 4, 5, 6, 7, respectively, in the carrier 1_1.

Second, the HARQ-ACK codebook for the serving cell is generated in the increasing order of the carrier index. So the HARQ-ACK codebook for cell 1 is a8, a9, a10, a11, a12, a13, a14, a15, a16, a17, a18, a19, a20, a21, a22, a23.

Third, the final HARQ-ACK codebook for the UE is generated in the increasing order of the serving cell index. So the final HARQ-ACK codebook is a0, a1, a2, a3, a4, a5, a6, a7, a8, a9, a10, a11, a12, a13, a14, a15, a16, a17, a18, a19, a20, a21, a22, a23, a24, a25, a26, a27, a28, a29, a30, a31.

### IV. Embodiment 4

In some embodiments, a UE is configured with a plurality of serving cells by the network. It is further configured that one or more serving cells have (or share) the same HARQ entity. The one or more the serving cells are associated with the one HARQ entity. For the plurality of the serving cells, a third HARQ-ACK codebook is generated in the order of the HARQ process indexes, in the order of the serving cells.

For the one or more serving cells associated with the same HARQ entity, only one codebook is generated for the HARQ entity. It means that only one serving cell from the one or more serving cells is considered when the third HARQ-ACK codebook is generated, e.g., the cell with the smallest cell index. The other serving cells are skipped when generating the third HARQ-ACK codebook.

A UE is configured with 4 serving cells by the network, which is denoted by cell 0, cell 1, cell 2, cell 3, respectively. It is further configured that cell 1 and cell 2 share the same HARQ entity. So only the cell 1 is considered in the third HARQ-ACK codebook generation and cell 2 is not considered.

According to the embodiments above, the HARQ-ACK codebook for the cell 0 is a0, a1, a2, a3, a4, a5, a6, a7. The HARQ-ACK codebook for the cell 1 is a8, a9, a10, a11, a12, a13, a14, a15. The HARQ-ACK codebook for the cell 3 is a16, a17, a18, a19, a20, a21, a22, a23. The final HARQ-ACK codebook is a0, a1, a2, a3, a4, a5, a6, a7, a8, a9, a10, a11, a12, a13, a14, a15, a16, a17, a18, a19, a20, a21, a22, a23.

### V. Embodiment 5

In some embodiments, a UE is configured with a plurality of the serving cells by the network. In a serving cell, a UE may be configured with a plurality of bandwidth part (BWP). The UE may be configured with more than one active BWP.

A control information includes a first BWP field and a second BWP field for indicating the active BWP change. The first BWP field indicates a first BWP, which may be the current active BWP. The second indicates a second BWP, which may be a non-active BWP currently. It indicates that the active BWP is changed from the first BWP to the second BWP. So after the UE receives the control information, the first BWP is deactivated and the second BWP is activated.

A control information includes a third field with a bitmap for indicating the active BWP. The length of the third field (e.g., the bitmap length) is configured by the network or equal to the number of the plurality of the bandwidth. Each bit in the bitmap corresponds to a BWP. The value ‘0’ of the bit indicates that the corresponding BWP is non-active. The value ‘1’ of the bit indicates that the corresponding BWP is active. From the UE perspective, after receiving a control information, the corresponding BWP indicated by a bit with value ‘1’ is activated and the corresponding BWP indicated by a bit with value ‘0’ is deactivated.

Within the more than one active BWP, a BWP is configured or specified as the reference BWP. The sub-carrier spacing (SCS) of the reference BWP is used for determine the TA value when the UE receives a TA command. For example, the BWP with the smallest BWP index within the more than one active BWP is the reference BWP for determining the TA value.

A first HARQ-ACK codebook is generated for the plurality of the serving cells in the order of the SLIV groups, in the order of the slot/sub-slot numbers, in the order of the BWPs within a serving cell, in the order of the serving cells. For example, the first HARQ-ACK codebook for the plurality of the serving cells is generated first in the increasing (or decreasing) order of the SLIV group index, second in the increasing (or decreasing) order of the slot/sub-slot number, third in the increasing (or decreasing) order of the BWP index, fourth in the increasing (or decreasing) order of the serving cell index.

A second control information is transmitted in a first PDCCH monitoring occasion in a first BWP in a first serving cell. A first DAI in the second control information indicates the accumulative number of third transmissions up to the first BWP, the first PDCCH monitoring occasion and the first serving cell. The third transmission includes at least a PDSCH scheduled by a PDCCH, a PDCCH indicating the SPS PDSCH release, a PDCCH indicating the SCell dormancy. The third transmission is presented in a BWP of a serving cell and in a PDCCH monitoring occasion.

A second DAI in the second control information indicates the total number of the third transmissions up to the first PDCCH monitoring occasion and is updated from PDCCH monitoring occasion to PDCCH monitoring occasion.

A second HARQ-ACK codebook is generated for the UE in the order of the PDSCH starting times, in the order of the BWPs, in the order of the serving cells, and in the order of the PDCCH monitoring occasions. For example, the second HARQ-ACK codebook for the UE is generated, first in the increasing (or decreasing) order of the PDSCH starting time for the same BWP and PDCCH monitoring occasion, second in the increasing (or decreasing) order of the BWP index within the same serving cell, third in the increasing (or decreasing) order of the serving cell index in the same PDCCH monitoring occasion, then in the increasing (or decreasing) order of the PDCCH monitoring occasion index. Alternatively, a second HARQ-ACK codebook is generated for the UE in the order of the first DAI value.

A third HARQ-ACK codebook is generated for the plurality of the serving cells in the order of the HARQ processes, in the order of the BWPs and in the order of the serving cells. For example, the third HARQ-ACK codebook is generated for the plurality of the serving cells, first in the increasing order of the HARQ process index, second in the increasing order of the BWP index in the same serving cell, third in the increasing order of the serving cell index.

### VI. Embodiment 6

In some embodiments, a UE is configured with a plurality of serving cells by the network. The network configures the UE to send a modulation and coding scheme (MCS) offset feedback corresponding to a data transmission, where the MCS offset is the difference between a first MCS and the MCS of the data transmission indicated by the network. The first MCS is the MCS is the maximum MCS such that the estimated block error rate (BLER) or bit error rate (BER) for the data transmission would be equal to or smaller than the target BLER or target BER. The target BLER and target BER is indicated by the network. The data transmission can be downlink data transmission, uplink data transmission, or sidelink data transmission.

Alternatively, the network configures the UE to send a SINR offset feedback corresponding to a data transmission, where the SINR offset is the difference between a first SINR and the detected SINR of the data transmission. The first SINR is the minimum SINR such that the estimated block error rate (BLER) or bit error rate (BER) for the data transmission would be equal to or smaller than the target BLER or target BER.

Alternatively, the network configures the UE to send a channel quality indicator (CQI) offset feedback corresponding to a data transmission, where the CQI offset is the difference between a first CQI and the second CQI. The first CQI is the maximum CQI such that the estimated block error rate (BLER) or bit error rate (BER) for the data transmission would be equal to or smaller than the target BLER or target BER. The second CQI is the latest CQI that is reported by the UE prior to the data transmission.

It is restricted that the network can only indicates the UE to send MCS offset, SINR offset, or CQI offset in the last DCI for scheduling the data transmission. From the UE perspective, the UE expects that only the last DCI can indicates the UE to send MCS offset, SINR offset, or CQI offset. For example, there is a field in the DCI to indicate the UE send the MCS offset, SINR offset, or CQI offset. The value ‘1’ indicates the UE to send the MCS offset, SINR offset, or CQI offset. The value ‘0’ indicates the UE not to send the MCS offset, SINR offset, or CQI offset. Then the UE expects that the value of the field is ‘1’ only in the last DCI. The UE expects that the value of the field is ‘0’ in the DCI other than the last DCI. The last DCI indicates the PUCCH resource for the HARQ-ACK codebook and or the offset.

The network configures the UE to send the MCS offset, SINR offset, or CQI offset for one or more serving cells in the plurality of serving cells. Each offset sub-codebook corresponds to a serving cell. More specifically, each offset sub-codebook corresponds to the latest one or more data transmission in the serving cell prior to the sub-codebook transmission. If there is no data transmission prior to the sub-codebook transmission or if the offset sub-codebook corresponds to the latest one or more data transmission has been reported, the default value is set for the sub-codebook. A fourth codebook is generated to include the MCS offset, SINR offset, or CQI offset for the one or more serving cells in the order of the serving cell index. Within a serving cell, the codebook is generated in the order of the carrier index. When the UE generates a HARQ-ACK codebook (e.g., a first HARQ-ACK codebook, a second HARQ-ACK codebook, or a third HARQ-ACK codebook), the UE generates the forth codebook and the fourth codebook is concatenated to codebook. Then the final codebook is transmitted by the UE. Still referring to FIG. 3, the network configures the UE to send the MCS offset for serving cell 0 and serving cell 1. So the fourth codebook is c0, c1, c2, c3, c4, c5, where c0, c1 is the MCS offset codebook for latest transmission in the carrier 0_0 prior to the fourth codebook transmission, and c2, c3 is the MCS offset codebook for latest transmission in the carrier 1_0 prior to the fourth codebook transmission, c4, c5 is the MCS offset codebook for latest transmission in the carrier 1_0 prior to the fourth codebook transmission. If there is no transmission in the carrier 1_0 prior to the fourth codebook transmission or if the offset codebook for the latest in the carrier 1_0 has been reported, c4, c5 is set to default value. Then the fourth codebook is concatenated to the first HARQ-ACK codebook, the second HARQ-ACK codebook, or the third HARQ-ACK codebook in the above embodiment.

The network can configure a plurality of specific PUCCH resource for the UE to send the fourth codebook. For example, the a periodic PUCCH resource is configured for the fourth codebook transmission. If there is another PUCCH overlapping with the periodic PUCCH, the UCI carried by the another PUCCH is concatenated to the fourth codebook.

The network can configure the UE to transmit the delta MCS, delta SINR, delta CQI for each transmission scheduled by the network via RRC signaling, MAC CE, or DCI. For example, a MAC CE indicates that UE transmits the delta MCS, delta SINR, delta CQI for each transmission. In this case, the delta MCS can be jointly coded with HARQ-ACK for each transmission. Alternatively, for each transmission, the corresponding delta MCS, delta CQI or delta SINR is concatenated to the corresponding HARQ-ACK bits. Then the joint code or the concatenated bits are concatenated by using the same rule as that used for generating the first HARQ-ACK codebook, the second HARQ-ACK codebook, or third HARQ-ACK codebook, as explained above.

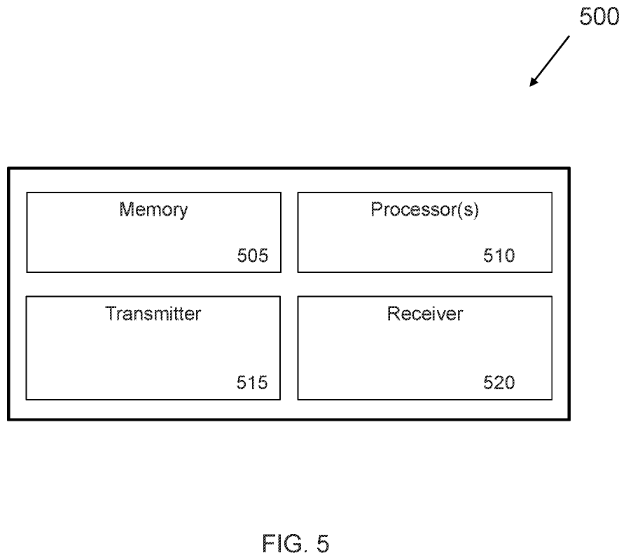

FIG. 5 shows an exemplary block diagram of a hardware platform 500 that may be a part of a network device (e.g., base station) or a communication device (e.g., user equipment). The hardware platform 500 includes at least one processor 510 and a memory 505 having instructions stored thereupon. The instructions upon execution by the processor 510 configure the hardware platform 500 to perform the operations described in FIGS. 1 to 4 and 6 to 10 and in the various embodiments described in this patent document. The transmitter 515 transmits or sends information or data to another device. For example, a network device transmitter can send a message to a user equipment. The receiver 520 receives information or data transmitted or sent by another device. For example, a user equipment can receive a message from a network device.

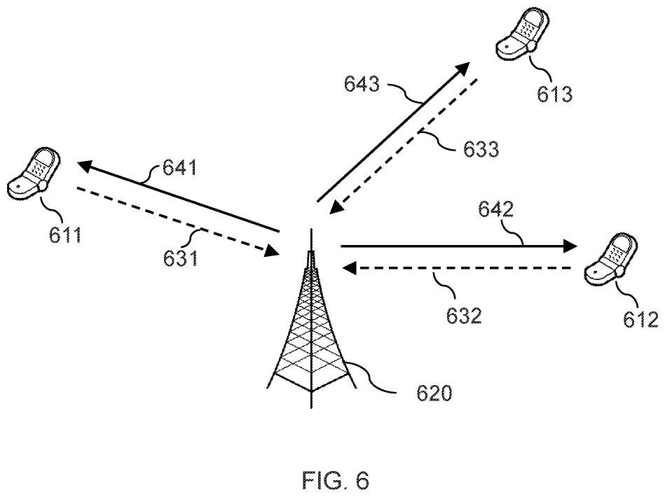

The implementations as discussed above will apply to a wireless communication. FIG. 6 shows an example of a wireless communication system (e.g., a 5G or NR cellular network) that includes a base station 620 and one or more user equipment (UE) 611, 612 and 613. In some embodiments, the UEs access the BS (e.g., the network) using a communication link to the network (sometimes called uplink direction, as depicted by dashed arrows 631, 632, 633), which then enables subsequent communication (e.g., shown in the direction from the network to the UEs, sometimes called downlink direction, shown by arrows 641, 642, 643) from the BS to the UEs. In some embodiments, the BS send information to the UEs (sometimes called downlink direction, as depicted by arrows 641, 642, 643), which then enables subsequent communication (e.g., shown in the direction from the UEs to the BS, sometimes called uplink direction, shown by dashed arrows 631, 632, 633) from the UEs to the BS. The UE may be, for example, a smartphone, a tablet, a mobile computer, a machine to machine (M2M) device, an Internet of Things (IoT) device, and so on.

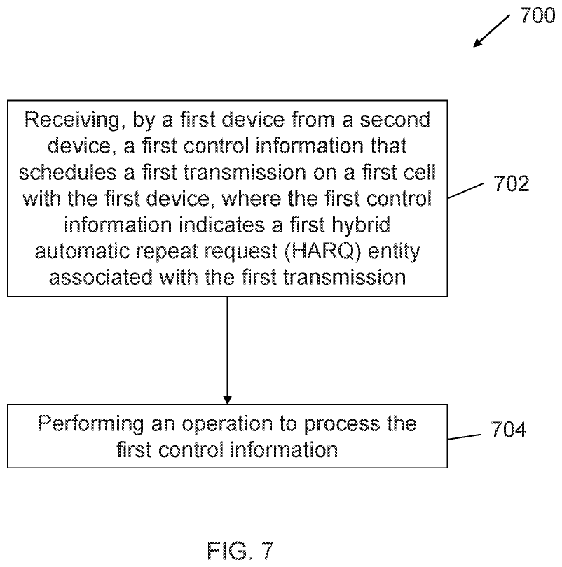

FIG. 7 shows a flowchart of an example method 700 for processing a control information that schedules a transmission. Operation 702 includes receiving, by a first device from a second device, a first control information that schedules a first transmission on a first cell with the first device, where the first control information indicates a first hybrid automatic repeat request (HARQ) entity associated with the first transmission. Operation 704 includes performing an operation to process the first control information.

In some embodiments, the example method 700 further includes receiving, by the first device from the second device, a radio resource control (RRC) signaling that indicates the first HARQ entity associated with a configured grant transmission or a semi-persistent transmission. In some embodiments for example method 700, the first control information includes a first HARQ process associated with the first transmission, where the operation to process the first control information includes: receiving, by the first device from the second device, a second control information that schedules a second transmission on a second cell with the first device prior to the first transmission, where the second control information indicates the first HARQ entity and the first HARQ process that are associated with the second transmission; and determining, by the first device, that the second transmission is previous transmission of the first transmission in time domain based on the first control information and the second control information.

In some embodiments, the example method 700 further includes determining whether the first transmission is a new transmission or a retransmission by comparing a first new data indicator (NDI) value in the first control information to a second NDI value in the second control information. In some embodiments for example method 700, the first transmission is determined to be a new transmission in response to the first NDI value being different than the second NDI value. In some embodiments for example method 700, the first transmission is determined to be a retransmission in response to the first NDI value being same as the second NDI value. In some embodiments for example method 700, the first device includes a user equipment (UE) and the second device includes a base station (BS). In some embodiments for example method 700, the first device includes a base station (BS) and the second device includes a user equipment (UE).

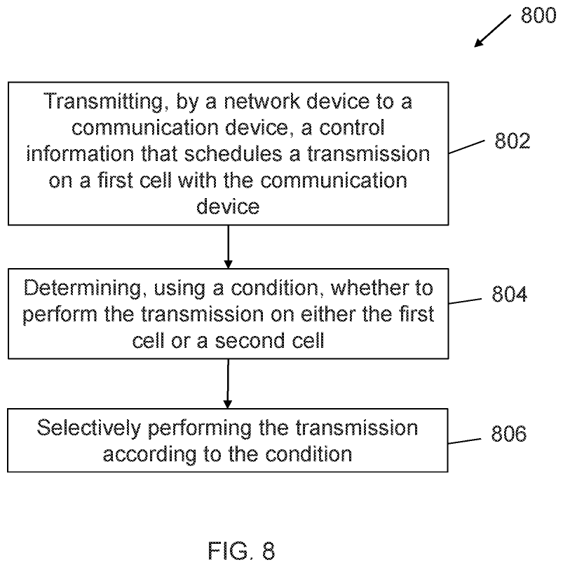

FIG. 8 shows a flowchart of an example method 800 for selectively performing a transmission based on a condition. Operation 802 includes transmitting, by a network device to a communication device, a control information that schedules a transmission on a first cell with the communication device. Operation 804 includes determining, using a condition, whether to perform the transmission on either the first cell or a second cell. Operation 806 includes selectively performing the transmission according to the condition.

In some embodiments for example method 800, the network device determines that the transmission cannot be performed on the first cell or that the transmission is performed on the second cell in response to the condition that indicates a collision between a transmission resource for the transmission and a slot format in the first cell. In some embodiments for example method 800, the network device determines that the transmission cannot be performed on the first cell or that the transmission is performed on the second cell in response to the condition that indicates an overlap in the first cell between a transmission resource of the transmission and a first resource that is not to be used for performing transmission with the communication device, and where the network device determines that the first resource is not to be used for performing transmission. In some embodiments for example method 800, the network device determines that the transmission cannot be performed on the first cell or that the transmission is performed on the second cell in response to the condition that indicates that another signal overlaps with the transmission and that the another signal has a priority that is higher than that of the transmission.

In some embodiments for example method 800, the network device determines that the transmission is performed on the second cell, and a first set of one or more configurations of the transmission are to be determined by one or more parameters in the control information and one or more configurations of the first cell, or a second set of one or more configurations of the transmission are to be determined by parameters in the control information and one or more configurations of the second cell.

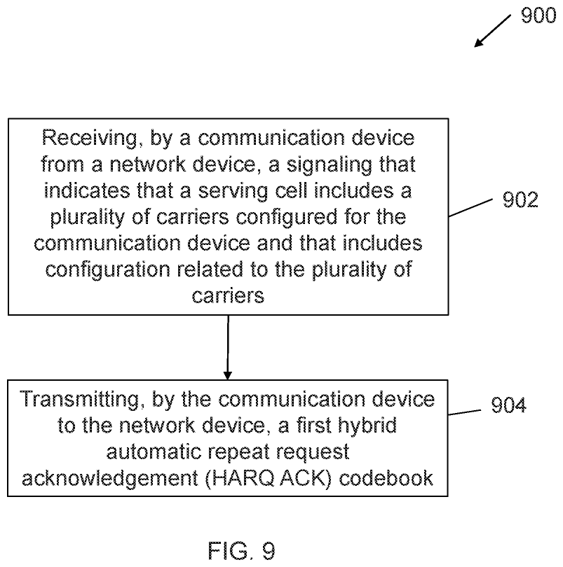

FIG. 9 shows a flowchart of an example method 900 for transmission of HARQ ACK codebook. Operation 902 includes receiving, by a communication device from a network device, a signaling that indicates that a serving cell includes a plurality of carriers configured for the communication device and that includes configuration related to the plurality of carriers. Operation 904 includes transmitting, by the communication device to the network device, a first hybrid automatic repeat request acknowledgement (HARQ ACK) codebook, where the first HARQ ACK codebook is determined for the plurality of carriers using: an ordered plurality of start and length indicator value (SLIV) groups in a plurality of slots for each carrier from the plurality of carriers, an ordered plurality of slot indexes or a plurality of sub-slot indexes for each carrier from the plurality of carriers, an ordered plurality of carrier indexes of the plurality of carriers within the serving cell, or an ordered plurality of serving cell indexes of a plurality of serving cells.

In some embodiments for example method 900, the control information includes a first downlink assignment index (DAI) that indicates an accumulative number of transmissions up to: a carrier from the plurality of carriers, or a serving cell from the plurality of serving cells, or a physical downlink control channel (PDCCH) monitoring occasion. In some embodiments for example method 900, the control information includes a second downlink assignment index (DAI) that indicates a total number of transmissions in one or more physical downlink control channel (PDCCH) monitoring occasions. In some embodiments, the example method 900 further includes transmitting, by the communication device to the network device, a second HARQ ACK codebook, where the second HARQ ACK codebook is determined using: an ordered plurality of HARQ process indexes, an ordered plurality of carrier indexes of the plurality of carriers, and an ordered plurality of serving cell indexes of a plurality of serving cells.

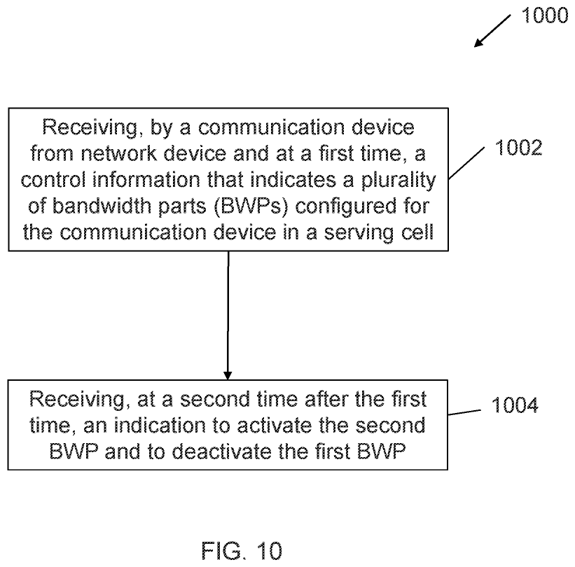

FIG. 10 shows a flowchart of an example method 1000 for managing bandwidth parts (BWPs). Operation 1002 includes receiving, by a communication device from network device and at a first time, a control information that indicates a plurality of bandwidth parts (BWPs) configured for the communication device in a serving cell, where the network device indicates a plurality of serving cells for the communication device, where the plurality of serving cells includes the serving cell, where the control information includes a first field that indicates that a first BWP from the plurality of BWPs is active, and where the control information includes a second field that indicates that a second BWP from the plurality of BWPs is non-active. Operation 1004 includes receiving, at a second time after the first time, an indication to activate the second BWP and to deactivate the first BWP.

In some embodiments for example method 1000, the control information includes a bitmap that includes a plurality of bits, where each bit in the bitmap corresponds to one BWP from the plurality of BWPs. In some embodiments, the example method 1000 further includes transmitting, by the communication device, a first hybrid automatic repeat request acknowledgement (HARQ ACK) codebook to the network device, where the first HARQ ACK codebook is determined for the plurality of serving cells using: an ordered plurality of start and length indicator value (SLIV) groups in a plurality of slots for each carrier from a plurality of carriers, an ordered plurality of slot indexes or a plurality of sub-slot indexes for each carrier from the plurality of carriers, an ordered plurality of BWP indexes of the plurality of BWPs, or an ordered plurality of serving cell indexes of the plurality of serving cells.

In some embodiments for example method 1000, the control information includes a first downlink assignment index (DAI) that indicates an accumulative number of transmissions up to: a BWP from the plurality of BWPs, or a serving cell from the plurality of serving cells, or a physical downlink control channel (PDCCH) monitoring occasion from a plurality of PDCCH monitoring occasions. In some embodiments for example method 1000, the control information includes a second downlink assignment index (DAI) that indicates a total number of transmissions in one or more physical downlink control channel (PDCCH) monitoring occasions.

In some embodiments, the example method 1000 further includes transmitting, by the communication device to the network device, a second hybrid automatic repeat request acknowledgement (HARQ ACK) codebook, where the second HARQ ACK codebook is determined using: an ordered plurality of HARQ process indexes, an ordered plurality of BWP indexes of the plurality of BWPs, or an ordered plurality of serving cell indexes of the plurality of serving cells.

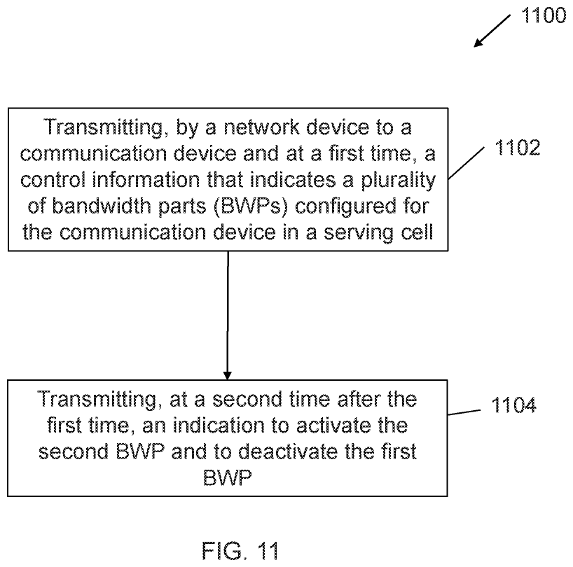

FIG. 11 shows a flowchart of an example method 1100 for indicating one or more BWPs. Operation 1102 includes transmitting, by a network device to a communication device and at a first time, a control information that indicates a plurality of bandwidth parts (BWPs) configured for the communication device in a serving cell, where the network device indicates a plurality of serving cells for the communication device, where the plurality of serving cells includes the serving cell, where the control information includes a first field that indicates that a first BWP from the plurality of BWPs is active, and where the control information includes a second field that indicates that a second BWP from the plurality of BWPs is non-active. Operation 1104 includes transmitting, at a second time after the first time, an indication to activate the second BWP and to deactivate the first BWP.

In some embodiments of example method 1100, the control information includes a bitmap that includes a plurality of bits, where each bit in the bitmap corresponds to one BWP from the plurality of BWPs. In some embodiments, the example method 1100 further includes receiving, by the network device, a first hybrid automatic repeat request acknowledgement (HARQ ACK) codebook, where the first HARQ ACK codebook is determined for the plurality of serving cells using: an ordered plurality of start and length indicator value (SLIV) groups in a plurality of slots for each carrier from a plurality of carriers, an ordered plurality of slot indexes or a plurality of sub-slot indexes for each carrier from the plurality of carriers, an ordered plurality of BWP indexes of the plurality of BWPs, or an ordered plurality of serving cell indexes of the plurality of serving cells.

In some embodiments of example method 1100, the control information includes a first downlink assignment index (DAI) that indicates an accumulative number of transmissions up to: a BWP from the plurality of BWPs, or a serving cell from the plurality of serving cells, or a physical downlink control channel (PDCCH) monitoring occasion from a plurality of PDCCH monitoring occasions. In some embodiments of example method 1100, the control information includes a second downlink assignment index (DAI) that indicates a total number of transmissions in one or more physical downlink control channel (PDCCH) monitoring occasions. In some embodiments, the example method 1100 further includes receiving, by the network device from the communication device, a second hybrid automatic repeat request acknowledgement (HARQ ACK) codebook, where the second HARQ ACK codebook is determined using: an ordered plurality of HARQ process indexes, an ordered plurality of BWP indexes of the plurality of BWPs, or an ordered plurality of serving cell indexes of the plurality of serving cells.

The follow section describes some example techniques for performing transmission scheduling as described in this patent document:
A control information for scheduling a transmission includes a field indicating the HARQ entity associated with the transmission. For a configured grant transmission, the associated HARQ entity is configured by the RRC signaling, and is further updated (e.g., modified) by the DCI, MAC CE.
A first cell is configured with a plurality of cells or one or more cells associated with the first cell, including, for example, the first candidate cell, the second candidate cell, the third candidate cell, and so on for the plurality of cells.
   A control information schedules a transmission transmitted on the first cell. The transmission cannot be transmitted on the first cell, if
      There is a collision between the resource of the transmission and the slot format, or
      There is an overlapping between the resource of the transmission and a first resource that is not used for the transmission to the UE based on the indication from the network
      There is another signal overlaps with the transmission and another signal has a higher priority than the transmission
   If the transmission on the first cell scheduled by the control information cannot be transmitted on the first cell, the transmission is transmitted on the first candidate cell
      Some the configuration of the transmission may is determined based on the indication in the control information and the configuration of the first cell and some of the configuration is determined based on the indication in the control information and the configuration of the first candidate cell.
A serving cell includes a plurality of the carriers.
   The first HARQ codebook is generated in the order of the in the order of the SLIV groups, in the order of the slot/sub-slot indexes, in the order of the carrier indexes, and in the order of the serving cells
   A first downlink assignment index in the control information indicates the accumulative number of the transmission up to the current carrier, serving cell and the PDCCH monitoring, where the control information is transmitted, counted in the order of the carriers, in the order of the serving cells, and in the order of the PDCCH monitoring.
   A second DAI in the control information indicates the total number of the transmission for all the carriers up to the current PDCCH monitoring occasion, where the control information is transmitted, counted in the order of the PDCCH monitoring occasions.
   A third HARQ codebook is generated in the order of the HARQ process indexes, in the order of the carriers, and in the order of the serving cells.
A plurality of the serving cells have the same HARQ entity. One of serving cell is taken into account and the other serving cell are skipped when generating the third HARQ codebook
A serving cell includes a plurality of active BWP
   The control information indicates the active BWP switch
      The control information includes a second field indicating the source BWP and the target BWP
      The control information includes a bitmap with each bit corresponding to a BWP
   The first HARQ codebook is generated in the order of the SLIV groups, in the order of the slot/sub-slot indexes, in the order of the BWP indexes, and in the order of the serving cells
   A first downlink assignment index in the control information indicates the accumulative number of the transmission up to the current BWP, serving cell and the PDCCH monitoring, where the control information is transmitted, counted in the order of the BWPs, in the order of the serving cells, and in the order of the PDCCH monitoring.
   A second DAI in the control information indicates the total number of the transmission for all the BWP in the serving cells up to the current PDCCH monitoring occasion, where the control information is transmitted, counted in the order of the PDCCH monitoring occasions.
   A third HARQ codebook is generated in the order of the HARQ process indexes, in the order of the BWPs, and in the order of the serving cells.

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1. A wireless communication method, comprising:
receiving, by a first device from a second device, a first control information that schedules a first transmission on a first cell with the first device,
wherein the first control information indicates a first hybrid automatic repeat request (HARQ) entity associated with the first transmission; and
performing an operation to process the first control information.

2. The method of claim 1, further comprising:
receiving, by the first device from the second device, a radio resource control (RRC) signaling that indicates the first HARQ entity associated with a configured grant transmission or a semi-persistent transmission.

3. The method of claim 1,
wherein the first control information includes a first HARQ process associated with the first transmission,
wherein the operation to process the first control information includes:
receiving, by the first device from the second device, a second control information that schedules a second transmission on a second cell with the first device prior to the first transmission,
wherein the second control information indicates the first HARQ entity and the first HARQ process that are associated with the second transmission; and
determining, by the first device, that the second transmission is previous transmission of the first transmission in time domain based on the first control information and the second control information.

4. The method of any of claims 1 to 3, further comprising:
determining whether the first transmission is a new transmission or a retransmission by comparing a first new data indicator (NDI) value in the first control information to a second NDI value in the second control information.

5. The method of claim 4, wherein the first transmission is determined to be a new transmission in response to the first NDI value being different than the second NDI value.

6. The method of claim 4, wherein the first transmission is determined to be a retransmission in response to the first NDI value being same as the second NDI value.

7. The method of any of claims 1 to 6, wherein the first device includes a user equipment (UE) and the second device includes a base station (BS).

8. The method of any of claims 1 to 6, wherein the first device includes a base station (BS) and the second device includes a user equipment (UE).

9. A wireless communication method, comprising:
transmitting, by a network device to a communication device, a control information that schedules a transmission on a first cell with the communication device;
determining, using a condition, whether to perform the transmission on either the first cell or a second cell; and
selectively performing the transmission according to the condition.

10. The method of claim 9, wherein the network device determines that the transmission cannot be performed on the first cell or that the transmission is performed on the second cell in response to the condition that indicates a collision between a transmission resource for the transmission and a slot format in the first cell.

11. The method of claim 9,
wherein the network device determines that the transmission cannot be performed on the first cell or that the transmission is performed on the second cell in response to the condition that indicates an overlap in the first cell between a transmission resource of the transmission and a first resource that is not to be used for performing transmission with the communication device, and
wherein the network device determines that the first resource is not to be used for performing transmission.

12. The method of claim 9, wherein the network device determines that the transmission cannot be performed on the first cell or that the transmission is performed on the second cell in response to the condition that indicates that another signal overlaps with the transmission and that the another signal has a priority that is higher than that of the transmission.

13. The method of claim 9,
wherein the network device determines that the transmission is performed on the second cell, and
wherein a first set of one or more configurations of the transmission are to be determined by one or more parameters in the control information and one or more configurations of the first cell, or
wherein a second set of one or more configurations of the transmission are to be determined by parameters in the control information and one or more configurations of the second cell.

14. A wireless communication method, comprising:
receiving, by a communication device from a network device, a signaling that indicates that a serving cell includes a plurality of carriers configured for the communication device and that includes configuration related to the plurality of carriers; and
transmitting, by the communication device to the network device, a first hybrid automatic repeat request acknowledgement (HARQ ACK) codebook, wherein the first HARQ ACK codebook is determined for the plurality of carriers using:
an ordered plurality of start and length indicator value (SLIV) groups in a plurality of slots for each carrier from the plurality of carriers,
an ordered plurality of slot indexes or a plurality of sub-slot indexes for each carrier from the plurality of carriers,
an ordered plurality of carrier indexes of the plurality of carriers within the serving cell, or
an ordered plurality of serving cell indexes of a plurality of serving cells.

15. The method of claim 14, wherein the control information includes a first downlink assignment index (DAI) that indicates an accumulative number of transmissions up to:
a carrier from the plurality of carriers, or
a serving cell from the plurality of serving cells, or
a physical downlink control channel (PDCCH) monitoring occasion.

16. The method of claim 14, wherein the control information includes a second downlink assignment index (DAI) that indicates a total number of transmissions in one or more physical downlink control channel (PDCCH) monitoring occasions.

17. The method of claim 14, further comprising:
transmitting, by the communication device to the network device, a second HARQ ACK codebook,
wherein the second HARQ ACK codebook is determined using:
an ordered plurality of HARQ process indexes,
an ordered plurality of carrier indexes of the plurality of carriers, and
an ordered plurality of serving cell indexes of a plurality of serving cells.

18. A wireless communication method, comprising:
receiving, by a communication device from network device and at a first time, a control information that indicates a plurality of bandwidth parts (BWPs) configured for the communication device in a serving cell,
wherein the network device indicates a plurality of serving cells for the communication device,
wherein the plurality of serving cells includes the serving cell,
wherein the control information includes a first field that indicates that a first BWP from the plurality of BWPs is active, and
wherein the control information includes a second field that indicates that a second BWP from the plurality of BWPs is non-active; and
receiving, at a second time after the first time, an indication to activate the second BWP and to deactivate the first BWP.

19. The method of claim 18, wherein the control information includes a bitmap that includes a plurality of bits, wherein each bit in the bitmap corresponds to one BWP from the plurality of BWPs.

20. The method of claim 18, further comprising:
transmitting, by the communication device, a first hybrid automatic repeat request acknowledgement (HARQ ACK) codebook to the network device,
wherein the first HARQ ACK codebook is determined for the plurality of serving cells using:
an ordered plurality of start and length indicator value (SLIV) groups in a plurality of slots for each carrier from a plurality of carriers,
an ordered plurality of slot indexes or a plurality of sub-slot indexes for each carrier from the plurality of carriers,
an ordered plurality of BWP indexes of the plurality of BWPs, or
an ordered plurality of serving cell indexes of the plurality of serving cells.

21. The method of claim 18, wherein the control information includes a first downlink assignment index (DAI) that indicates an accumulative number of transmissions up to:
a BWP from the plurality of BWPs, or
a serving cell from the plurality of serving cells, or
a physical downlink control channel (PDCCH) monitoring occasion from a plurality of PDCCH monitoring occasions.

22. The method of claim 18, wherein the control information includes a second downlink assignment index (DAI) that indicates a total number of transmissions in one or more physical downlink control channel (PDCCH) monitoring occasions.

23. The method of claim 18, further comprising:
transmitting, by the communication device to the network device, a second hybrid automatic repeat request acknowledgement (HARQ ACK) codebook,
wherein the second HARQ ACK codebook is determined using:
an ordered plurality of HARQ process indexes,
an ordered plurality of BWP indexes of the plurality of BWPs, or
an ordered plurality of serving cell indexes of the plurality of serving cells.

24. A wireless communication method, comprising:
transmitting, by a network device to a communication device and at a first time, a control information that indicates a plurality of bandwidth parts (BWPs) configured for the communication device in a serving cell,
wherein the network device indicates a plurality of serving cells for the communication device,
wherein the plurality of serving cells includes the serving cell,
wherein the control information includes a first field that indicates that a first BWP from the plurality of BWPs is active, and
wherein the control information includes a second field that indicates that a second BWP from the plurality of BWPs is non-active; and
transmitting, at a second time after the first time, an indication to activate the second BWP and to deactivate the first BWP.

25. The method of claim 24, wherein the control information includes a bitmap that includes a plurality of bits, wherein each bit in the bitmap corresponds to one BWP from the plurality of BWPs.

26. The method of claim 24, further comprising:
receiving, by the network device, a first hybrid automatic repeat request acknowledgement (HARQ ACK) codebook,
wherein the first HARQ ACK codebook is determined for the plurality of serving cells using:
an ordered plurality of start and length indicator value (SLIV) groups in a plurality of slots for each carrier from a plurality of carriers,
an ordered plurality of slot indexes or a plurality of sub-slot indexes for each carrier from the plurality of carriers,
an ordered plurality of BWP indexes of the plurality of BWPs, or
an ordered plurality of serving cell indexes of the plurality of serving cells.

27. The method of claim 24, wherein the control information includes a first downlink assignment index (DAI) that indicates an accumulative number of transmissions up to:
a BWP from the plurality of BWPs, or
a serving cell from the plurality of serving cells, or
a physical downlink control channel (PDCCH) monitoring occasion from a plurality of PDCCH monitoring occasions.

28. The method of claim 24, wherein the control information includes a second downlink assignment index (DAI) that indicates a total number of transmissions in one or more physical downlink control channel (PDCCH) monitoring occasions.

29. The method of claim 24, further comprising:
receiving, by the network device from the communication device, a second hybrid automatic repeat request acknowledgement (HARQ ACK) codebook,
wherein the second HARQ ACK codebook is determined using:
an ordered plurality of HARQ process indexes,
an ordered plurality of BWP indexes of the plurality of BWPs, or
an ordered plurality of serving cell indexes of the plurality of serving cells.

30. An apparatus for wireless communication comprising a processor, configured to implement a method recited in one or more of claims 1 to 29.

31. A non-transitory computer readable program storage medium having code stored thereon, the code, when executed by a processor, causing the processor to implement a method recited in one or more of claims 1 to 29.
